(19) United States
(12) Patent Application Publication
(10) Pub. No.: US 2019/0204839 A1
(43) Pub. Date: Jul. 4, 2019

(54) METHOD AND SYSTEM FOR GENERATING A SAFE NAVIGATION PATH FOR A VEHICLE

(71) Applicant: WIPRO LIMITED, Bangalore (IN)

(72) Inventors: Balaji Sunil Kumar, Bengaluru (IN); Manas Sarkar, Kolkata (IN)

(73) Assignee: Wipro Limited

(21) Appl. No.: 15/900,870

(22) Filed: Feb. 21, 2018

(30) Foreign Application Priority Data
Dec. 28, 2017 (IN) 201741047114

(51) Int. Cl. G05D 1/02

(52) U.S. Cl. CPC G05D 1/0212

(57) ABSTRACT

Disclosed subject matter relates to a field of telematics that performs a method for generating safe navigation path for navigating a vehicle. A path generation system associated with the vehicle may receive a reference path, between source point and destination point, confined between left and right boundaries of road. Further, the path generation system may determine plurality of boundary points positioned along selected boundary and may identify a tangent for a point positioned between adjacent determined boundary points from along the selected boundary. Further, a line perpendicular to the tangent may be projected from each of the plurality of boundary points until the perpendicular line reaches other boundary. The path generation system may identify centre point on each perpendicular line and connects each centre point to venerate the safe navigation path at centre of road that minimizes jerks and ensures smooth navigation and free movement of vehicle on road.

### TECHNICAL FIELD

The present subject matter relates generally to field of telematics, and more particularly, but not exclusively to a method and a system for generating a safe navigation path for navigating a vehicle in the field of telematics.

### BACKGROUND

Generally, vehicles make use of navigation path for navigating from a source point to a destination point. Nowadays, the navigation path is widely used for navigating vehicles, for example, autonomous vehicles in different application areas. Autonomous vehicles are the vehicles that are capable of sensing environment around them for moving on the road without any human intervention. The autonomous vehicles sense the environment with the help of sensors configured in the autonomous vehicles such as Laser, Light Detection and Ranging (LIDAR), Global Positioning System (GPS), computer vision and the like.

The existing techniques related to generation of the navigation path may utilize various mechanisms such as “Travel Route Generation considering Vehicle Constraint while vehicle is moving”, “Simulation based Vehicle Path Detection”, “Lane Estimation using Camera and LIDAR”, “Path detection using camera on vehicle”, and the like. However, the existing techniques may generate the navigation path that may navigate the vehicle close to boundaries of the road or close to obstacle positions. The existing techniques may not consider free space present around the vehicle while generating the navigation path which leads to generation of the navigation path which is close to the boundaries or the obstacles. Due to the generation of such navigation paths close to the boundaries, the vehicles may experience situations where the vehicles may not have enough space for free movement in places such as curves, U-turns and the like. Further, the vehicle may experience frequent jerks while moving along the navigation path which is generated close to the boundaries or the obstacles.

Therefore, the existing techniques may generate the navigation path for navigating the vehicles along the generated path, but, may not generate the navigation path that ensures smooth navigation and free movement of the vehicles on the road.

### SUMMARY

One or more shortcomings of the prior art may be overcome, and additional advantages may be provided through the present disclosure. Additional features and advantages may be realized through the techniques of the present disclosure. Other embodiments and aspects of the disclosure are described in detail herein and are considered apart of the claimed disclosure.

Disclosed herein is a method for generating a safe navigation path for navigating a vehicle. The method comprising receiving, by a path generation system associated with the vehicle, a reference path between a source point and a destination point from one or more sources. The reference path is confined between boundaries of a road characterised as a left-side boundary and a right-side boundary. Further, the path generation system determines a plurality of boundary points positioned along a boundary selected from the left-side boundary and the right-side boundary by traversing the selected boundary. Upon determining the plurality of boundary points, the path generation system identifies a tangent for a point along the selected boundary. The point is positioned between adjacent determined boundary points from each of the determined plurality of boundary points. Further, a line perpendicular to the tangent is projected from each of the plurality of boundary points until the perpendicular line reaches other boundary. Furthermore, the path generation system identifies a centre point on each perpendicular line. Finally, each centre point is connected to generate the safe navigation path.

Further, the present disclosure includes a path generation system for generating a safe navigation path for navigating a vehicle. The path generation system includes a processor and a memory communicatively coupled to the processor. The memory stores the processor-executable instructions, which, on execution, causes the processor to receive a reference path between a source point and a destination point from one or more sources. The reference path is confined between boundaries of a road characterised as a left-side boundary and a right-side boundary. Further, the processor determines a plurality of boundary points positioned along a boundary selected from the left-side boundary and the right-side boundary by traversing the selected boundary. Upon determining the plurality of boundary points, the processor identifies a tangent for a point along the selected boundary. The point is positioned between adjacent determined boundary points from each of the determined plurality of boundary points. Further, a line perpendicular to the tangent is projected from each of the plurality of boundary points until the perpendicular line reaches other boundary. Furthermore, the processor identifies a centre point on each perpendicular line. Finally, each centre point is connected to generate the safe navigation path.

Furthermore, the present disclosure includes a non-transitory computer readable medium including instructions stored thereon that when processed by at least one processor causes a path generating system to perform operations including receiving a reference path between a source point and a destination point from one or more sources. The reference path is confined between boundaries of a road characterised as a left-side boundary and a right-side boundary. Further, the instructions cause the processor to determine a plurality of boundary points positioned along a boundary selected from the left-side boundary and the right-side boundary by traversing the selected boundary. Upon determining the plurality of boundary points, the instructions cause the processor to identify a tangent for a point along the selected boundary, the point is positioned between adjacent determined boundary points from each of the determined plurality of boundary points. A line perpendicular to the tangent is projected from each of the plurality of boundary points until the perpendicular line reaches other boundary. Finally, the instructions cause the processor to identify a centre point on each perpendicular line, wherein each centre point is connected to generate the safe navigation path.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DIAGRAMS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

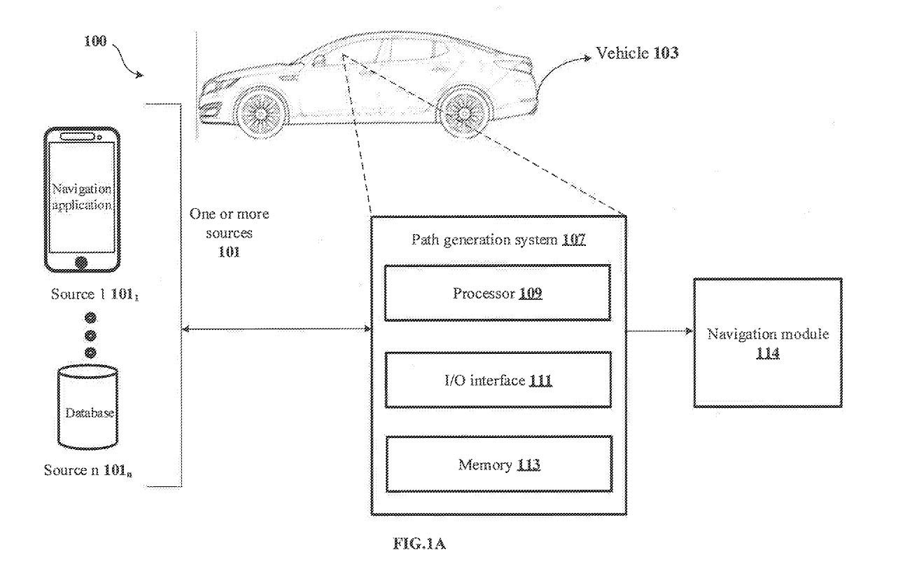

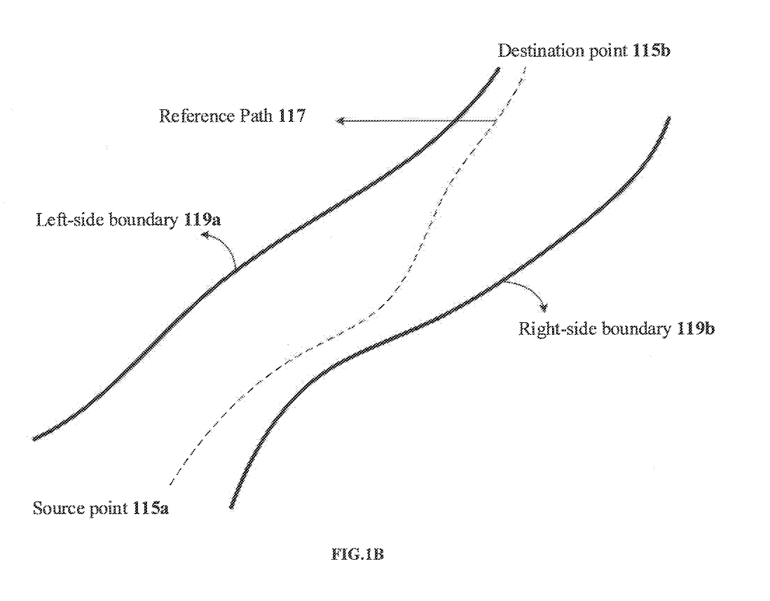

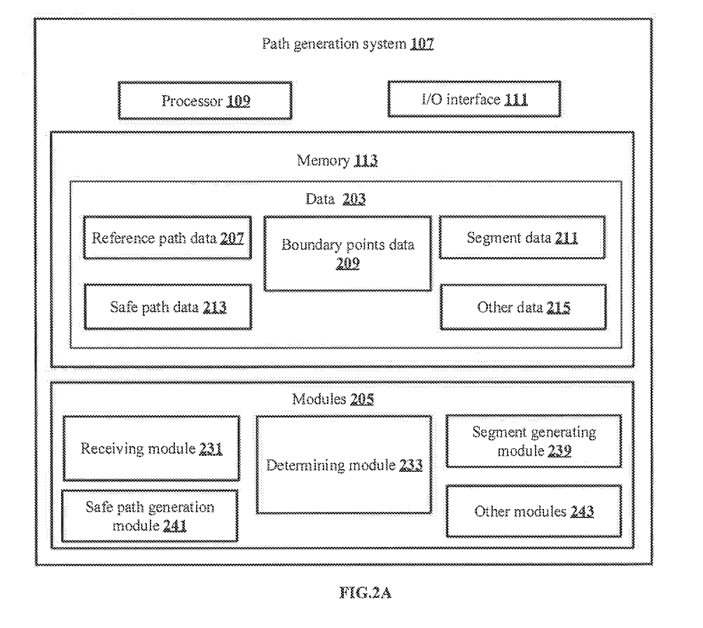

FIG. 1A shows an exemplary architecture for generating a safe navigation path for navigating a vehicle in accordance with some embodiments of the present disclosure;

FIG. 1B shows an exemplary depiction of a reference path in accordance with some embodiments of the present disclosure;

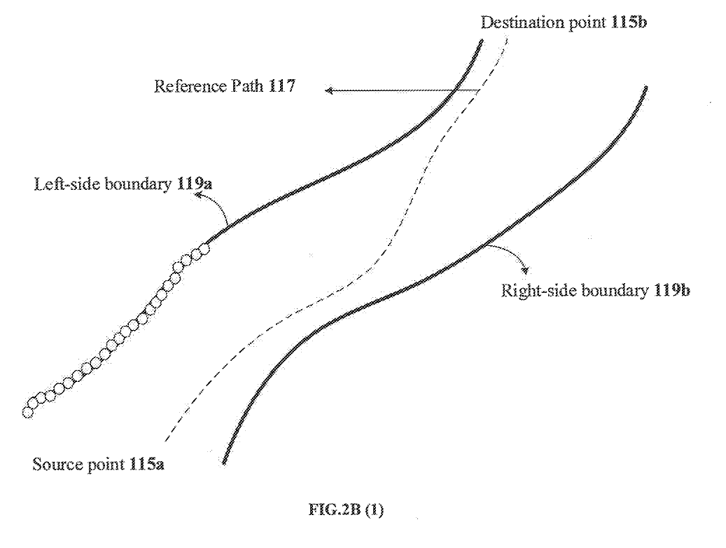

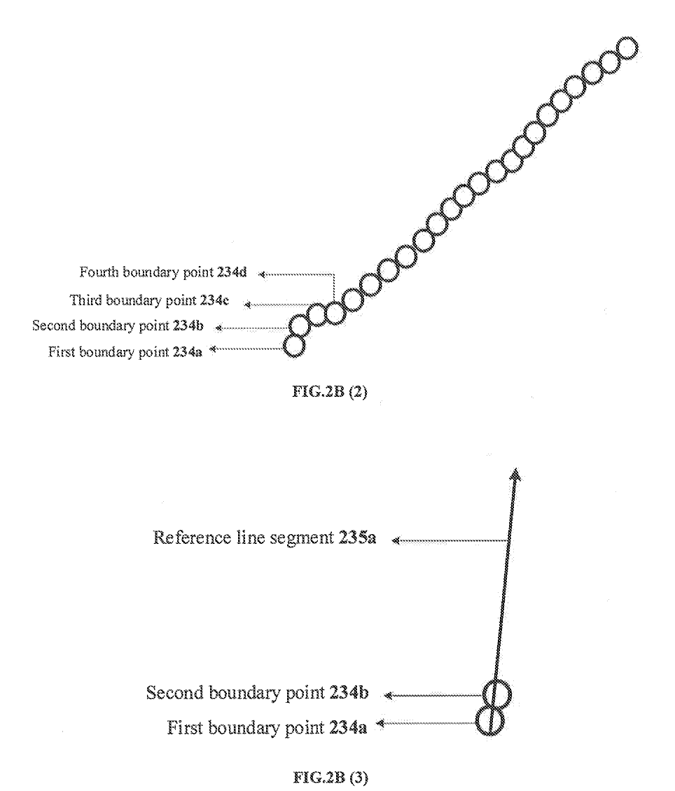

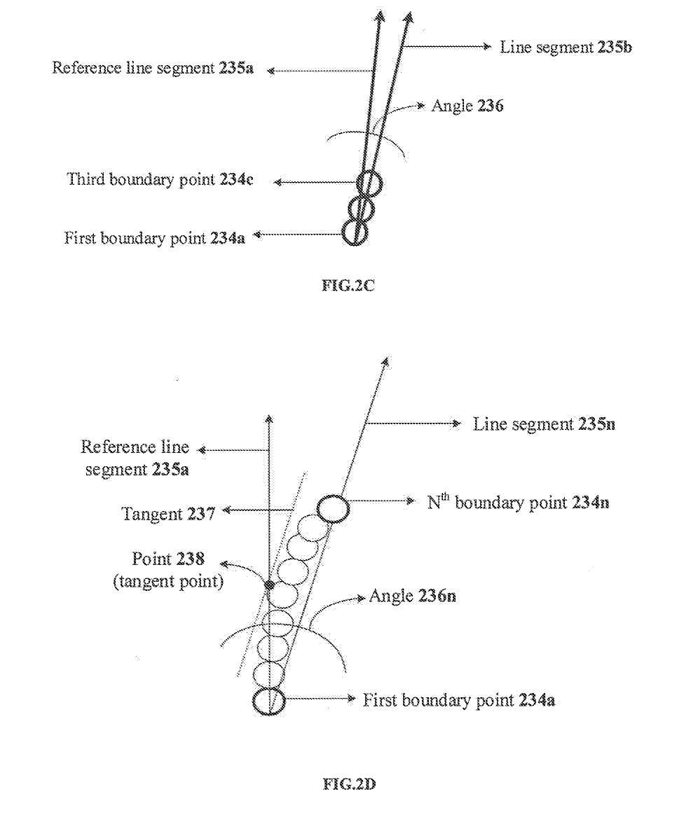

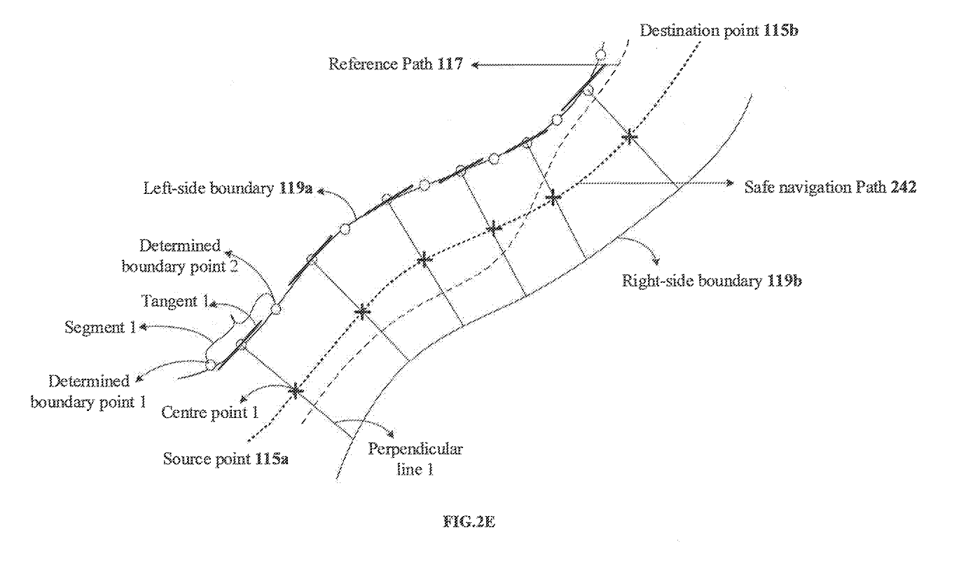

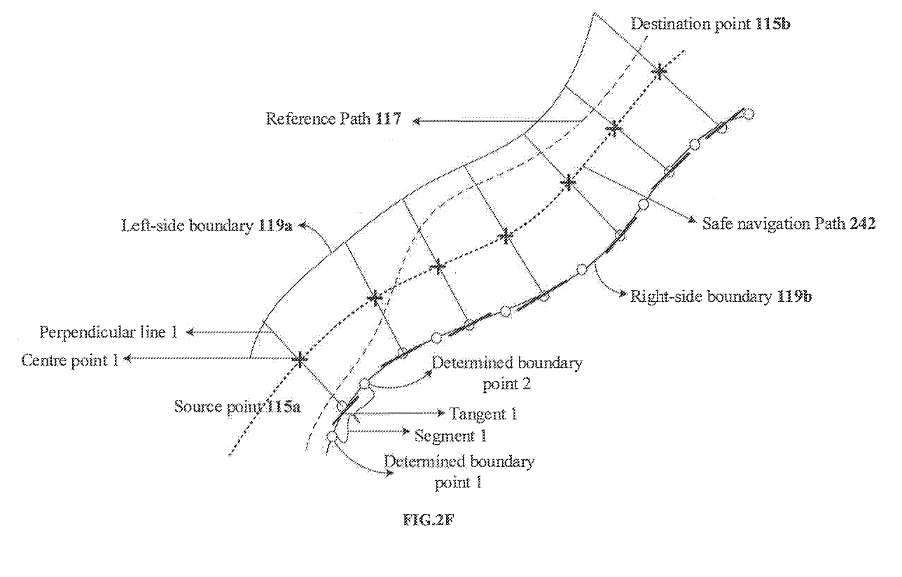

FIG. 2A shows a detailed block diagram of a path generation system for generating a safe navigation path for navigating a vehicle in accordance with some embodiments of the present disclosure;

FIG. 2B (1) and FIG. 2B (2) show exemplary representations of boundary points along a boundary of the reference path in accordance with some embodiments of the present disclosure;

FIG. 2B (3) shows an exemplary reference line segment in accordance with some embodiments of the present disclosure;

FIG. 2C and FIG. 2D shows an exemplary line segment between two boundary points in accordance with some embodiments of the present disclosure;

FIG. 2E and FIG. 2F show an exemplary representation of a safe navigation path in accordance with some embodiments of the present disclosure;

FIG. 3 shows a flowchart illustrating a method of generating a safe navigation path for navigating a vehicle in accordance with some embodiments of the present disclosure; and

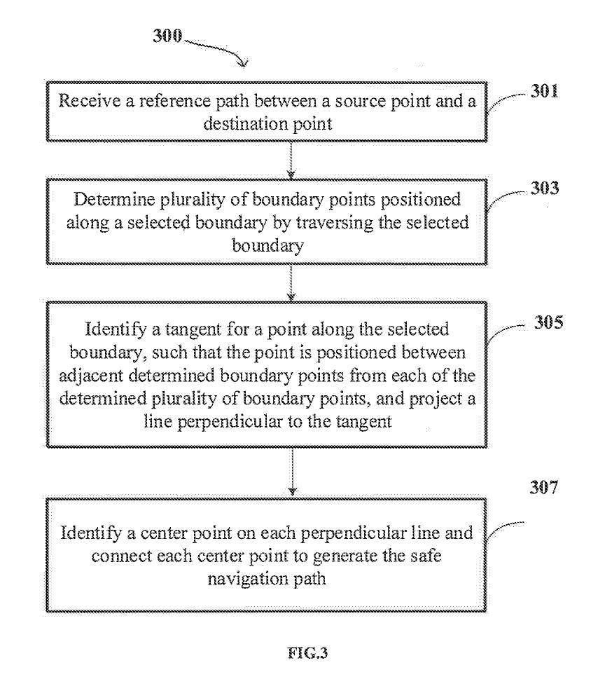

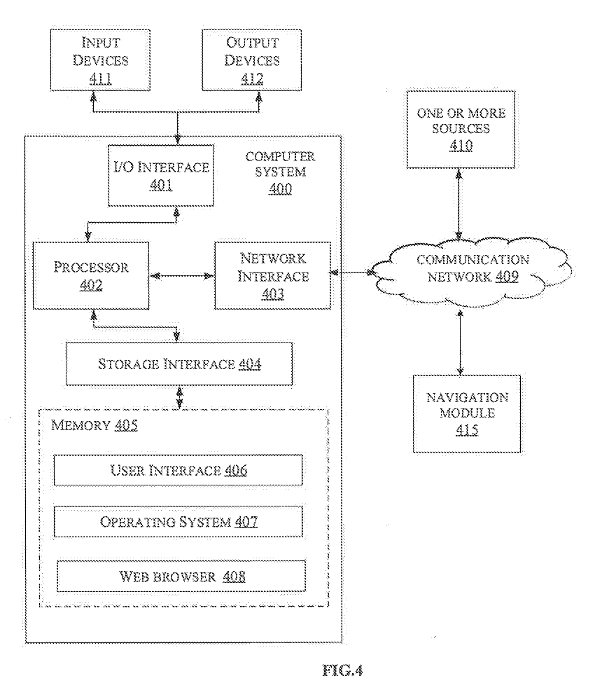

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration,” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternative falling within the scope of the disclosure.

The terms “comprises”, “comprising”, “includes” or any other variations thereof, are intended to cover a non-exclusive inclusion, such that a setup, device or method that includes a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

Disclosed herein are a method and a system for generating a safe navigation path for navigating a vehicle. A path generation system associated with the vehicle, may receive a reference path between a source point and a destination point from one or more sources. As an example, the one or more sources may include, but not limited to, an application related to maps such as a navigation application and a database storing static maps. The reference path may be confined between boundaries of a road characterised as a left-side boundary and a right-side boundary. Further, the path generation system may select one boundary from the left-side boundary and the right-side boundary. Upon selecting the boundary, the path generation system may determine a plurality of boundary points along the selected boundary by traversing the selected boundary. In some embodiments, the plurality of boundary points may be determined based on generation of one or more segments along the selected boundary. Each of the one or more segments may include one of the plurality of boundary points. Further, the path generation system may identify a tangent for a point along the selected boundary. The point may be positioned between adjacent determined boundary points from each of the determined plurality of boundary points. Furthermore, the path generation system may project a line perpendicular to the tangent from each of the plurality of boundary points until the perpendicular line reaches other boundary. Finally, the path generation system identifies a centre point on each perpendicular line and may connect each centre point identified on each perpendicular line to generate the safe navigation path. The safe navigation path generated in the present disclosure is at centre of the road. Therefore, the safe navigation path may provide sufficient space for manoeuvring the vehicle, thereby overcoming the constraints related to vehicle length, vehicle width, turning radius and the like. Also, the safe navigation path generated in the present disclosure provides a smooth navigation for the vehicle by minimizing jerks while driving the vehicle.

A description of an embodiment with several components in communication with each other does not imply that all such components are required. On the contrary a variety of optional components are described to illustrate the wide variety of possible embodiments of the disclosure.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

FIG. 1A shows an exemplary architecture for generating a safe navigation path for navigating a vehicle in accordance with some embodiments of the present disclosure.

The architecture 100 includes one or more sources, source 101₁ to source 101ₐ (collectively referred as one or more sources 101), a vehicle 103, a path generation system 107 and a navigation module 114. As an example, the one or more sources 101 may include, but not limited to, an application related to maps such as a navigation application and a database storing static maps. In some embodiments, the one or more sources 101 may provide static maps generated using Light Detection and Ranging (LIDAR). In some embodiments, the one or more sources 101 may be associated with the path generation system 107 via a communication network (not shown in FIG. 1A). As an example, the communication network may include a wired communication network or a wireless communication network. In some embodiments, the path generation system 107 may be configured within the vehicle 103 as shown in the FIG. 1A. In some other embodiments, the path generation system 107 may be remotely associated with the vehicle 103 via the wireless communication network. In some embodiments, the vehicle 103 may be an autonomous vehicle or a non-autonomous vehicle. As an example, the vehicle 103 may be a bike, a car, a truck, a bus and the like.

The path generation system 107 includes a processor 109, an Input/Output (I/O) interface 111 and a memory 113. The I/O interface 111 may be configured to receive a reference path 117 between a source point 115a and a destination point 115b, from the one or more sources 101. In some embodiments, the reference path 117 may be confined between boundaries of a road characterized as a left-side boundary 119a and a right-side boundary 119b as shown in the FIG. 1B. The one or more sources 101 may obtain the reference path 117 using one or more predefined standard techniques such as Dijkstra's algorithm, A-star algorithm and the like, upon receiving the source point 115a and the destination point 115b. In some embodiments, the source point 115a and the destination point 115b may be provided as inputs to the path generation system 107 by a user associated with the path generation system 107. Further, the processor 109 may store the reference path 117 in the memory 113 coupled with the processor 109. Upon receiving the reference path 117, the processor 109 may select a boundary from the left-side boundary 119a and the right-side boundary 119b. Further,the processor 109 may determine plurality of boundary points positioned along the selected boundary by traversing the selected boundary. Upon determining the plurality of boundary points, the processor 109 may identify a tangent for a point along the selected boundary. The point may be positioned between adjacent determined boundary points from each of the determined plurality of boundary points. Further, the processor 109 may project a line perpendicular to the tangent from each of the plurality of boundary points until the perpendicular line reaches other boundary. In some embodiments, the other boundary may be defined as one among the left-side boundary 119a and the right-side boundary 119b which may not be initially selected by the processor 109 for determining the plurality of boundary points. Upon projecting the perpendicular line from each of the plurality of boundary points, the processor 109 may identify a centre point on each perpendicular line.

Finally, the processor 109 may connect each centre point identified on each perpendicular line to generate a safe navigation path for navigating the vehicle 103. In some embodiments, the processor 109 may use one or more predefined curve fitting techniques to connect each centre point on each perpendicular line. Upon generating the safe navigation path, the processor 109 may provide the generated safe navigation path to a navigation module 114 associated with the path generation system 107 for navigating the vehicle 103, in some embodiments, the navigation module 114 may be configured in the vehicle 103. The navigation module 114 may determine a command velocity for the vehicle 103 based on dynamic data received for navigating the vehicle 103 on the road. In some embodiments, the navigation module 114 may re-plan the generated safe navigation path or deviate from the generated safe navigation path when the vehicle 103 may be anticipated to encounter one or more obstacles on the road.

FIG. 2A shows a detailed block diagram of a path generation system for generating a safe navigation path for navigating a vehicle in accordance with some embodiments of the present disclosure.

In some implementations, the path generation system 107 may include data 203 and modules 205. As an example, the data 203 is stored in a memory 113 configured in the path generation system 107 as shown in the FIG. 2A. In one embodiment, the data 203 may include a reference path data 207, boundary points data 209, a segment data 211, a safe path data 213 and other data 215. In the illustrated FIG. 2A, modules 205 are described herein in detail.

In some embodiments, the data 203 may be stored in the memory 113 in form of various data structures. Additionally, the data 203 can be organized using data models, such as relational or hierarchical data models. The other data 215 may store data, including temporary data and temporary files, generated by the modules 205 for performing the various functions of the path generation system 107.

In some embodiments, the data 203 stored in the memory 113 may be processed by the modules 205 of the path generation system 107. The modules 205 may be stored within the memory 113. In an example, the modules 205 communicatively coupled to the processor 109 configured in the path generation system 107, may also be present outside the memory 113 as shown in FIG. 2A and implemented as hardware. As used herein, the term modules may refer to an application specific integrated circuit (ASIC), an electronic circuit, a processor (shared, dedicated, or group) and memory that execute one or more software or firmware programs, a combinational logic circuit, and/or other suitable components that provide the described functionality.

In some embodiments, the modules 205 may include, for example, a receiving module 231, a determining module 233, a segment generating module 239, a safe path generation module 241 and other modules 243. The other modules 243 may be used to perform various miscellaneous functionalities of the path generation system 107. It will be appreciated that such aforementioned modules 205 may be represented as a single module or a combination of different modules.

In some embodiments, the receiving module 231 may receive a reference path 117 between a source point 115a and a destination point 115b, from one or more sources 101 when the vehicle 103 is yet to start journey from the source point 115a to the destination point 115b. In some embodiments, the reference path 117 may be confined between boundaries of a road characterized as a left-side boundary 119a and a right-side boundary 119b. The reference path 117 along with the source point 115a and a destination point 115b may be stored as the reference path data 207. Further, as an example, the one or more sources 101 may include, but not limited to, an application related to maps such as a navigation application and a database storing static maps. In some embodiments, the one or more sources 101 may provide static maps generated using Light Detection and Ranging (LIDAR).

In some embodiments, the determining module 233 may determine plurality of boundary points positioned along a boundary selected from the left-side boundary 119a and the right-side boundary 119b. The determining module 233 may determine the plurality of boundary points based on generation of one or more segments by traversal of the selected boundary. The plurality of boundary points maybe stored as the boundary points data 209. The one or more segments may be stored as the segment data 211. In some embodiments, each segment of the one or more segments may comply with at least one of the pre-defined segment length threshold and the pre-defined segment inclination threshold. Further, each of the one or more segments may include a proposed boundary point which is detected to be a determined boundary point, when the segment complies with at least the pre-defined segment length threshold and the pre-defined segment inclination threshold. In some embodiments, the method of determining the plurality of boundary points based on the generation of the one or more segments is explained below using exemplary values for better understanding. However, the exemplary values should not be considered as a limitation for the present disclosure.

In some embodiments, to determine the plurality of boundary points, the determining module 233 may select the boundary from the left-side boundary 119a and the right-side boundary 119b. As an example, consider that the determining module 233 selected the left-side boundary 119a for determining the plurality of boundary points. Therefore, the right-side boundary 119b may be defined as other boundary relative to the selected boundary.

The determining module 233 may visualize the selected boundary as a continuous accumulation of boundary points as shown in the FIG. 2B (1). Further, a zoomed view of the selected boundary accumulated with the boundary points such as a first boundary point 234a, a second boundary point 234b, a third boundary point 234c and the like is as shown in the FIG. 2B (2). Further, the determining module 233 may identify a line segment between the first boundary point 234a and the second boundary point 234b as a reference line segment 235a as shown in the FIG. 2B (3). Upon identifying the reference line segment 235a, the determining module 233 may traverse along the selected boundary, one boundary point at a given point of time. In some embodiments, each boundary point that the determining module 233 may traverse may be considered to be a proposed boundary point, until the determined boundary point is detected. As an example, consider that the determining module 233 is about to traverse the third boundary point 234c. Therefore, the third boundary point 234c would be considered as the proposed boundary point for the current traversal. Similarly, for the next traversal, a fourth boundary point 234d would be considered as the proposed boundary point.

As an example, consider the third boundary point 234c as the proposed boundary point. The determining module 233 may draw a line segment 235b between the first boundary point 234a and the third boundary point 234c as shown in the FIG. 2C. Upon drawing the line segment 235b, the determining module 233 may determine an angle 236 between the reference line segment 235a and the line segment 235b. Upon determining the angle 236, the determining module 233 may compare the angle 236 with a pre-defined segment inclination threshold. As an example, consider that the pre-defined segment inclination threshold is 10 degrees. Based on the comparison, if the angle 236 is determined to be greater than the pre-defined segment inclination threshold, the segment generating module 239 may generate a segment at the third boundary point 234c. The third boundary point 234c at which the segment is generated, may be the determined boundary point of the segment. In some embodiments, the determined boundary point is obtained at an intersection of the selected boundary and the generated segment. Based on the comparison, if the angle 236 is determined to be less than the pre-defined segment inclination threshold, the determining module 233 may proceed to next traversal by selecting the fourth boundary point 234d as the proposed boundary point. Upon selecting the fourth boundary point 234d, the determining module 233 may re-iterate the method explained above. The determining module 233 may re-iterate the above-mentioned method by traversing the proposed boundary points one after the other until one of the proposed boundary points exceeds the pre-defined segment inclination threshold.

As an example, consider the values determined by the determining module 233 as shown in the below Table 1.

TABLE 1

| | | | Determined | |
|---|---|---|---|---|
| | | Predefined | angle between | |
| | | segment | reference line | |
| | Boundary point | inclination | segment and | |
| | considered as | threshold | current line | |
| Traversal | proposed | (in | segment (in | Threshold |
| No. | boundary point | degrees) | degrees) | exceeded |
| 1 | 1^{st} boundary point | 10 | 5 | No |
| 2 | 2^{nd} boundary point | 10 | 7 | No |
| 3 | 3^{rd} boundary point | 10 | 8 | No |
| 4 | 4^{th} boundary point | 10 | 10.5 | Yes |

Therefore, according to the above Table 1, the fourth boundary point 234d exceeds the pre-defined segment inclination threshold. Therefore, the segment generating module 239 may generate the segment at the fourth boundary point 234d, thereby obtaining the determined boundary point of the segment, which is considered as one of the determined plurality of boundary points along the selected boundary.

In some embodiments, the determining module 233 may re-iterate the above-mentioned method until one of the boundary points exceeds the pre-defined segment length threshold. Further, the segment generating module 239 may generate the segment at the boundary point where the pre-defined segment threshold length is exceeded. In this scenario, though the one of the boundary points may not have exceeded the pre-defined segment inclination threshold, the segment generating module 239 may still generate the segment since the one of the boundary point exceeded the pre-defined segment length threshold. As an example, consider that the pre-defined segment length threshold is 5 metres. Consider that the number of boundary points traversed by the determining module 233 may correspond to the pre-defined segment length threshold “5 metres”. However, the boundary point which exceeded the pre-defined segment length threshold, may not be exceeding the predefined segment inclination threshold. In such a scenario, the segment generating module 239 may generate the segment at the boundary point where the pre-defined segment length threshold was exceeded, since the boundary point is complying with at least one of the pre-defined segment length threshold and the pre-defined segment inclination threshold. Therefore, the boundary point at which the segment is generated, may be the determined boundary point of the segment.

In some embodiments, each segment generated by the segment generating module 239 may include the proposed boundary point that may change for every successive traversal until the segment generating module 239 generates the segment, thereby detecting the determined boundary point for the segment at the intersection of the selected boundary and the generated segment. Therefore, the plurality of boundary points may be determined by the determining module 233 based on the generation of one or more segments by the segment generating module 239. Further, the determining module 233 may determine the plurality of boundary points and the segment generating module 239 may generate one or more segments corresponding to each of the determined plurality of boundary points till the end of the reference path 117.

In some embodiments, a line segment between the determined boundary point of the generated segment and a successive boundary point may be considered as a next reference line segment for generating a next segment along the selected boundary, until the end of the reference path 117.

In some embodiments, upon determining the plurality of boundary points and upon generating the one or more segments along the selected boundary, the safe path generation module 241 may identify a tangent for a point (also referred to as a tangent point) along the selected boundary. The tangent point 238 may be positioned between adjacent determined boundary points from each of the determined plurality of boundary points as shown in the FIG. 2D. In the FIG. 2D, consider that the boundary point represented as 234a is the first boundary point and the boundary point represented as 234n is a “n^{th}” boundary point on the selected boundary. For the current traversal, the determining module 233 may consider the “n^{th}” boundary point 234n along the selected boundary, as the proposed boundary point. Further, the FIG. 2D represents the reference line segment 235a, and a line segment 235n between the first boundary point 234a and the “n^{th}” boundary point 234n, to determine an angle 236n. Furthermore, consider that the angle 236n between the reference line segment 235a and the line segment 235n exceeded the pre-defined segment inclination threshold. Therefore, the determining module 233 may detect the proposed boundary point i.e. the “n^{th}” boundary point 234n, as the determined boundary point, where the segment generating module 239 may generate the segment, since the segment complies with at least the pre-defined segment length threshold and the pre-defined segment inclination threshold. Also, the first boundary point 234a and the “n^{th}” boundary point 234n may be considered as the adjacent determined boundary points. Further, the safe path generation module 241 may identify the tangent for a point between the adjacent determined boundary points, 234a and 234n. To identify the tangent, the safe path generation module 241 may project a line, touching the selected boundary, parallel to the line segment 235n as shown in the FIG. 2D. In some embodiments, the safe path generation module 241 may identify the line projected parallel to the line segment 235n as the tangent 237 to the selected boundary that touches the selected boundary at the point (tangent point) 238 positioned between the adjacent determined boundary points, 234a and 234n, as shown in the FIG. 2D. Similarly, the safe path generation module 241 may generate the tangents between each of the adjacent determined boundary points as shown in the FIG. 2E.

As an example, as shown in the FIG. 2E, tangent 1 may be the tangent identified between the adjacent determined boundary points 1 and 2, for the generated segment 1. In the FIG. 2E, the generated segment 1 may be the area between the adjacent determined boundary points 1 and 2. Further, the safe path generation module 241 may project a line perpendicular to the tangent from each of the determined plurality of boundary points until the perpendicular line reaches the other boundary as shown in the FIG. 2E. Furthermore, the safe path generation module 241 may identify a centre point on each perpendicular line corresponding to each of the determined plurality of boundary points as shown in the FIG. 2E. As an example, as shown in the FIG. 2E, perpendicular line 1 may be projected from tangent 1 on the left-side boundary 119a till the right-side boundary 119b. Further, a centre point 1 may be identified on the perpendicular line 1 of the segment 1. Upon identifying the centre point, the safe path generation module 241 may connect each centre point identified on each perpendicular line using one or more predefined curve fitting techniques, to generate the safe navigation path 242 as shown in the FIG. 2E. The generated safe navigation path maybe stored as the safe path data 213. Upon generating the safe navigation path 242, the safe path generation module 241 may provide the generated safe navigation path 242 to a navigation module 114 associated with the path generation system 107 for navigating the vehicle 103. In some embodiments, the navigation module 114 may be configured in the vehicle 103. The navigation module 114 may determine a command velocity for the vehicle 103 based on dynamic data received for navigating the vehicle 103 on the road. As an example, the dynamic data may include, but not limited to, data related to one or more obstacles appearing in real-time when the vehicle 103 is navigating along the safe navigation path 242 and data related to terrain associated with the safe navigation path 242. In some embodiments, the navigation module 114 may re-plan the generated safe navigation path 242 or deviate from the generated safe navigation path 242 when the vehicle 103 may be anticipated to encounter the one or more obstacles on the road.

In some embodiments, the safe navigation path 242 may be generated by selecting the right-side boundary 119b as shown in the FIG. 2F, using the same method as explained above for generating the safe navigation path 242 by selecting the left-side boundary 119a.

FIG. 3 shows a flowchart illustrating a method of generating a safe navigation path for navigating a vehicle in accordance with some embodiments of the present disclosure.

As illustrated in FIG. 3, the method 300 includes one or more blocks illustrating a method of generating a safe navigation path for navigating a vehicle 103. The method 300 may be described in the general context of computer executable instructions. Generally, computer executable instructions can include routines, programs, objects, components, data structures, procedures, modules, and functions, which perform functions, or implement abstract data types.

The order in which the method 300 is described is not intended to be construed as a limitation, and any number of the described method blocks can be combined in any order to implement the method 300. Additionally, individual blocks may be deleted from the methods without departing from the spirit and scope of the subject matter described herein. Furthermore, the method 300 can be implemented in any suitable hardware, software, firmware, or combination thereof.

At block 301, the method 300 may include receiving, by a processor 109 of the path generation system 107, a reference path 117 between a source point 115a and a destination point 115b from one or more sources 101. The reference path 117 may be confined between boundaries of a road characterised as a left-side boundary 119a and a right-side boundary 119b. The one or more sources 101 may obtain the reference path 117 using one or more predefined standard techniques such as Dijkstra's algorithm, A-star algorithm and the like, upon receiving the source point 115a and the destination point 115b.

At block 303, the method 300 may include determining, by the processor 109, a plurality of boundary points positioned along a boundary selected from the left-side boundary 119a and the right-side boundary 119b by traversing the selected boundary. In some embodiments, the plurality of boundary points may be determined based on generation of one or more segments by traversal of the selected boundary. Each of the generated one or more segments may comply with at least one of a pre-defined segment length threshold and a pre-defined segment inclination threshold.

At block 305, the method 300 may include, identifying, by the processor 109, a tangent for a point along the selected boundary. The point may be positioned between adjacent determined boundary points from each of the determined plurality of boundary points. Upon determining the tangent, the processor 109 may project a line perpendicular to the tangent from each of the plurality of boundary points until the perpendicular line reaches other boundary.

At block 307, the method 300 may include, identifying, by the processor 109, a centre point on each perpendicular line. Each centre point identified on each perpendicular line is connected using one or more predefined curve fitting techniques to generate the safe navigation path 242 for navigating the vehicle 103.

FIG. 4 is a block diagram of an exemplary computer system for implementing embodiments consistent with the present disclosure.

In some embodiments, FIG. 4 illustrates a block diagram of an exemplary computer system 400 for implementing embodiments consistent with the present invention. In some embodiments, the computer system 400 can be path generation system 107 that is used for generating a safe navigation path for navigating a vehicle 103. The computer system 400 may include a central processing unit (“CPU” or “processor”) 402. The processor 402 may include at least one data processor for executing program components for executing user or system-generated business processes. A user may include a person, a person using a device such as such as those included in this invention, or such a device itself. The processor 402 may include specialized processing units such as integrated system (bus) controllers, memory management control units, floating point units, graphics processing units, digital signal processing units, etc.

The processor 402 may be disposed in communication with input devices 411 and output devices 412 via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 401, computer system 400 may communicate with input devices 411 and output devices 412.

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the computer system 400 may communicate with one or more sources 410 (410ₐ up to 410ₐ), and a navigation module 415. The communication network 409 can be implemented as one of the different types of networks, such as intranet or Local Area Network (LAN), Closed Area Network (CAN) and such within the vehicle. The communication network 409 may either be a dedicated network or a shared network, which represents an association of the different types of networks that use a variety of protocols, for example, Hypertext Transfer Protocol (HTTP), CAN Protocol, Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc. The one or more sources 410 may include, but not limited to, a navigation application, an application related to maps and a database comprising static maps. In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, a user interface 406, an operating system 407, a web browser 408 etc. In some embodiments, the computer system 400 may store user/application data, such as the data, variables, records, etc. as described in this invention. Such databases may be implemented as fault-tolerant, relational, scalable, secure databases such as Oracle or Sybase.

The operating system 407 may facilitate resource management and operation of the computer system 400. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), International Business Machines (IBM) OS/2, Microsoft Windows (XP, Vista/7/8, etc.), Apple iOS, Google Android, Blackberry Operating System (OS), or the like. The User interface 406 may facilitate display, execution, interaction, manipulation, or operation of program components through textual or graphical facilities. For example, user interfaces may provide computer interaction interface elements on a display system operatively connected to the computer system 400, such as cursors, icons, check boxes, menus, strollers, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 400 may implement the web browser 408 stored program components. The web browser 408 may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming interfaces (APIs), etc. In some embodiments, the computer system 400 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft.NET, Common Gateway Interface (CGI) scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

Advantages of the Embodiment of the Present Disclosure are Illustrated Herein.

The present disclosure provides a method and a system for generating a safe navigation path for navigating a vehicle.

The safe navigation path generated in the present disclosure is at centre of the road, thereby providing sufficient space for manoeuvring the vehicle, thereby overcoming the constraints related to vehicle length, vehicle width, turning radius and the like.

The safe navigation path generated in the present disclosure provides a smooth navigation for the vehicle by minimizing jerks while driving the vehicle.

A description of an embodiment with several components in communication with each other does not imply that all such components are required. On the contrary a variety of optional components are described to illustrate the wide variety of possible embodiments of the invention.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The specification has described a method and a system for generating a safe navigation path for navigating a vehicle. The illustrated steps are set out to explain the exemplary embodiments shown, and it should be anticipated that on-going technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

Referral numerals

| Reference | |
|---|---|
| Number | Description |
| 100 | Architecture |
| 101 | One or more sources |
| 103 | Vehicle |
| 107 | Path generation system |
| 109 | Processor |
| 111 | I/O interface |
| 113 | Memory |
| 114 | Navigation module |
| 115a | Source point |
| 115b | Destination point |
| 117 | Reference path |
| 119a | Left-side boundary |
| 119b | Right-side boundary |
| 203 | Data |
| 205 | Modules |
| 207 | Reference path data |
| 209 | Boundary points data |
| 211 | Segment data |
| 213 | Safe path data |
| 215 | Other data |
| 231 | Receiving module |
| 233 | Determining module |
| 234a | First boundary point |
| 234b | Second boundary point |
| 234c | Third boundary point |
| 234d | Fourth boundary point |
| 234n | N^{th} boundary point |
| 235a | Reference line segment |
| 235b | Line segment between first boundary point and third |
| | boundary point |
| 235n | Line segment between first boundary point 234a and n^{th} |
| | boundary point 234n |
| 236 | Angle between the reference line segment 235a and the line |
| | segment 235b |
| 236n | Angle between the reference line segment 235a and the line |
| | segment 235n |
| 237 | Tangent corresponding to first boundary point 234a and n^{th} |
| | boundary point 234n |
| 238 | Point corresponding to tangent 237 |
| 239 | Segment generating module |
| 241 | Safe path generation module |
| 242 | Safe navigation path |
| 243 | Other modules |
| 400 | Exemplary computer system |
| 401 | I/O Interface of the exemplary computer system |
| 402 | Processor of the exemplary computer system |
| 403 | Network Interface |
| 404 | Storage interface |
| 405 | Memory of the exemplary computer system |
| 406 | User interface |
| 407 | Operating system |
| 408 | Web browser |
| 409 | Communication network |
| 410 | One or more sources of the exemplary computing system |
| 411 | Input devices |
| 412 | Output devices |
| 415 | Navigation module of the exemplary computing system |

What is claimed is:

1. A method for generating a safe navigation path (242) for navigating a vehicle (103), the method comprising:
receiving, by a path generation system (107) associated with the vehicle (103), a reference path (117) between a source point (115a) and a destination point (115b) from one or more sources (101), wherein the reference path (117) is confined between boundaries of a road characterised as a left-side boundary (119a) and a right-side boundary (119b);
determining, by the path generation system (107), a plurality of boundary points positioned along a boundary selected from the left-side boundary (119a) and the right-side boundary (119b) by traversing the selected boundary;
identifying, by the path generation system (107), a tangent for a point along the selected boundary, wherein the point is positioned between adjacent determined boundary points from each of the determined plurality of boundary points, and wherein a line perpendicular to the tangent is projected from each of the plurality of boundary points until the perpendicular line reaches other boundary; and
identifying, by the path generation system (107), a centre point on each perpendicular line, wherein each centre point is connected to generate the safe navigation path (242).

2. The method as claimed in claim 1, wherein the plurality of boundary points are determined based on generation of one or more segments by traversal of the selected boundary.

3. The method as claimed in claim 2, wherein each segment from the one or more segments comprises a proposed boundary point which is detected to be a determined boundary point, when the segment complies with at least a pre-defined segment length threshold and a pre-defined segment inclination threshold.

4. The method as claimed in claim 3, wherein each boundary point traversed on the selected boundary is considered to be the proposed boundary point, until the determined boundary point is detected.

5. The method as claimed in claim 1, wherein the identified tangent is parallel to a line segment generated between the adjacent determined boundary points.

6. The method as claimed in claim 1 further comprises providing, by the path generation system (107), the generated safe navigation path (242) to a navigation module associated with the path generation system (107) for navigating the vehicle (103).

7. A path generation system (107) for generating a safe navigation path (242) for navigating a vehicle (103), the path generation system (107) comprising:
a processor (109); and
a memory (113) communicatively coupled to the processor (109), wherein the memory (113) stores the processor-executable instructions, which, on execution, causes the processor (109) to:
receive a reference path (117) between a source point (115a) and a destination point (115b) from one or more sources (101), wherein the reference path (117) is confined between boundaries of a road characterised as a left-side boundary (119a) and a right-side boundary (119b);
determine a plurality of boundary points positioned along a boundary selected from the left-side boundary (119a) and the right-side boundary (119b) by traversing the selected boundary;
identify a tangent for a point along the selected boundary, wherein the point is positioned between adjacent determined boundary points from each of the determined plurality of boundary points, and wherein a line perpendicular to the tangent is projected from each of the plurality of boundary points until the perpendicular line reaches other boundary; and
identify a centre point on each perpendicular line, wherein each centre point is connected to generate the safe navigation path (242).

8. The path generation system (107) as claimed in claim 7, wherein the processor (109) determines the plurality of boundary points based on generation of one or more segments by traversal of the selected boundary.

9. The path generation system (107) as claimed in claim 8, wherein each segment from the one or more segments comprises a proposed boundary point which is detected to be a determined boundary point, when the segment complies with at least a pre-defined segment length threshold and a pre-defined segment inclination threshold.

10. The path generation system (107) as claimed in claim 9, wherein the processor (109) considers each boundary point traversed on the selected boundary to be the proposed boundary point, until the determined boundary point is detected.

11. The path generation system (107) as claimed in claim 7, wherein the identified tangent is parallel to a line segment generated between the adjacent determined boundary points.

12. The path generation system (107) as claimed in claim 7, wherein the processor (109) is further configured to provide the generated safe navigation path (242) to a navigation module associated with the path generation system (107) for navigating the vehicle (103).

13. A non-transitory computer readable medium including instructions stored thereon that when processed by at least one processor (109) causes a path generation system (107) to perform operations comprising:
receiving a reference path (117) between a source point (115a) and a destination point (115b) from one or more sources (101), wherein the reference path (117) is confined between boundaries of a road characterised as a left-side boundary (119a) and a right-side boundary (119b);
determining a plurality of boundary points positioned along a boundary selected from the left-side boundary (119a) and the right-side boundary (119b) by traversing the selected boundary;
identifying a tangent for a point along the selected boundary, wherein the point is positioned between adjacent determined boundary points from each of the determined plurality of boundary points, and wherein a line perpendicular to the tangent is projected from each of the plurality of boundary points until the perpendicular line reaches other boundary; and
identifying a centre point on each perpendicular line, wherein each centre point is connected to generate the safe navigation path (242).
